(19) United States
(12) Patent Application Publication
(10) Pub. No.: US 2026/0202018 A1
(43) Pub. Date: Jul. 16, 2026

(54) COMPRESSED NATURAL GAS CHILLING FOR FILLING OPERATION

(71) Applicant: CNX Resources Corporation, Canonsburg, PA (US)

(72) Inventor: Kevin Robert Egeland, Pittsburgh, PA (US)

(21) Appl. No.: 19/020,779

(22) Filed: Jan. 14, 2025

(51) Int. Cl. F17C 5/06

(52) U.S. Cl. CPC F17C 5/06; F17C 2205/0338; F17C 2221/033; F17C 2227/0323

(57) ABSTRACT

This disclosure presents a method for dispensing compressible fluids, specifically natural gas, using a heat exchanger to optimize temperature and pressure conditions. The process involves receiving a first supply stream at an initial temperature and expanding a second supply stream to a lower pressure. Heat is exchanged between these streams within the heat exchanger, reducing the temperature of the first stream for efficient dispensing. This method is particularly suited for filling compressed natural gas (CNG) tanks, ensuring continuous operation without interruptions. The system maintains the first stream's pressure below 4,500 psig and achieves a target density based on reference conditions. Additionally, the method supports integration with natural gas pipelines, maintaining suitable discharge temperatures. The approach enhances energy efficiency by eliminating the need for auxiliary refrigeration, making it ideal for onsite wellhead applications. This innovative system offers a streamlined solution for CNG operations, promoting economic and environmental benefits.

### TECHNICAL FIELD

The present disclosure generally relates to systems and methods for dispensing compressible fluids, with a focus on compressed natural gas (CNG) dispensing operations. The disclosed systems and methods prevent excessively high temperatures in a high-pressure gas stream at the outlet of a dispensing line, without employing auxiliary power.

### BACKGROUND

Compressible fluids, such as those in gaseous or supercritical phases, can be dispensed as pressurized streams. During dispensing, a stream is fed into a vessel until the contents of the vessel reach a sufficiently high density, depending on the intended use. For instance, long-range compressed natural gas (CNG) trucking operations may require vessels to be nearly 100% full, where the fill fraction is defined relative to the fluid's density at reference conditions such as, for example, 3,600 psig and 70° F. However, dispensing can lead to issues like rising temperature of the gas within the vessel. Traditional methods often use electricity to refrigerate the pressurized stream or introduce delays to address these issues, either of which can be inefficient and/or costly. Therefore, developing methods that dispense compressible fluids without electrical power or process interruptions to maintain vessel temperatures is desirable.

### SUMMARY

In a first embodiment, a method for dispensing a compressible fluid includes receiving a first supply stream comprising the compressible fluid at a first temperature into a heat exchanger via a first flow path. The method further includes expanding, via a flow regulator, a second supply stream comprising the compressible fluid at a first pressure to a second pressure that is lower than the first pressure and receiving the second supply stream at the second pressure into a second flow path of the heat exchanger. The method further includes transferring heat between the first supply stream and the second supply stream within the heat exchanger to prepare the first supply stream for dispensing at a second temperature lower than the first temperature and discharging the first supply stream at the second temperature from the first flow path to a dispensing operation.

In one aspect of the first embodiment, the compressible fluid includes natural gas.

In another aspect, the second temperature is in a range of −10° F. to 90° F.

In another aspect, which can be combined with one or more of the previously recited aspects of the first embodiment, the first supply stream includes water-dry natural gas.

In another aspect, which can be combined with one or more of the previously recited aspects of the first embodiment, the dispensing operation includes filling a tank via the first supply stream at the second temperature.

In another aspect, which can be combined with one or more of the previously recited aspects of the first embodiment, the dispensing operation includes filling a tank from a nominally empty state without interruption.

In another aspect, which can be combined with one or more of the previously recited aspects of the first embodiment, the dispensing operation includes continuously filling a tank until reaching a predetermined fill state based on at least one of a target density of the compressible fluid within the tank or a reference pressure and reference temperature indicative of the target density.

In another aspect, which can be combined with one or more of the previously recited aspects of the first embodiment, the compressible fluid includes natural gas and a pressure of the first supply stream at the second temperature is no greater than 4,500 psig.

In another aspect, which can be combined with one or more of the previously recited aspects of the first embodiment, the dispensing operation includes continuously filling a tank until reaching a predetermined fill state that is at least 80% of a target density of the compressible fluid.

In another aspect, which can be combined with one or more of the previously recited aspects of the first embodiment, the second pressure is at or above a natural gas pipeline operating pressure.

In another aspect, which can be combined with one or more of the previously recited aspects of the first embodiment, the method further includes discharging the second supply stream from the heat exchanger into a natural gas pipeline.

In another aspect, which can be combined with one or more of the previously recited aspects of the first embodiment, transferring heat between the first supply stream and the second supply stream in the heat exchanger maintains the second supply stream being discharged at a temperature suitable for flowing into a natural gas pipeline.

In another aspect, which can be combined with one or more of the previously recited aspects of the first embodiment, the method includes maintaining, via the flow regulator, the first supply stream being discharged at or below the second temperature.

In another aspect, which can be combined with one or more of the previously recited aspects of the first embodiment, the method includes receiving at least one of the first supply stream or the second supply stream from a natural gas process stream produced onsite at a wellpad.

In another aspect, which can be combined with one or more of the previously recited aspects of the first embodiment, the compressible fluid includes natural gas and the second supply stream further includes water and at least one hydrate inhibitor.

In another aspect, which can be combined with one or more of the previously recited aspects of the first embodiment, the method further includes transferring heat between an upstream portion of the second supply stream and a downstream portion of the second supply stream. In this aspect, the upstream portion includes a portion of the second supply stream at the first pressure and upstream of the flow regulator, and the downstream portion includes a portion of the second supply stream at the second pressure after transferring heat with the first supply stream.

In another aspect, which can be combined with one or more of the previously recited aspects of the first embodiment, the compressible fluid of the first supply stream within the heat exchanger is a supercritical fluid.

In a second embodiment, a method for filling a compressed natural gas (CNG) tank includes portioning a pressurized natural gas stream into a plurality of streams comprising a fill stream and a utility stream, expanding, via a throttling device, a utility stream from a first pressure to a second pressure, receiving the fill stream at a first temperature into a first flow channel of a heat exchanger, receiving the utility stream at the second pressure into a second flow channel of the heat exchanger, exchanging, via the heat exchanger, heat between the fill stream and the utility stream to reduce a temperature of the fill stream within the heat exchanger, and continuously discharging the fill stream within the heat exchanger from the first flow channel into the CNG tank until reaching a fill state suitable for an extended use CNG operation.

In one aspect of the second embodiment, the pressurized natural gas stream is produced onsite at a wellpad.

In a third embodiment, a system for dispensing a first stream of pressurized natural gas onsite at a wellpad includes a flow regulator and a heat exchanger. The flow regulator expands a second stream of pressurized natural gas produced onsite at the wellpad into an expanded natural gas stream to reduce a temperature of the second stream based on the expansion. The heat exchanger includes a first flow channel to accept the first stream of pressurized natural gas and a second flow channel to accept the expanded natural gas stream from the flow regulator, the second flow channel being in thermal communication with the first flow channel. The system further includes a first flow junction to convey the expanded natural gas stream from the second flow channel of the heat exchanger to a production pipeline system for downstream distribution of natural gas. The system further includes a second flow junction to convey the first stream of pressurized natural gas from the heat exchanger into a wellpad compressed natural gas dispensing operation.

These and other features and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of any of the aspects disclosed herein.

### BRIEF DESCRIPTION OF THE DRAWINGS

In the description, for purposes of explanation and not limitation, specific details are set forth, such as particular aspects, procedures, techniques, etc. to provide a thorough understanding of the present technology. However, it will be apparent to one skilled in the art that the present technology may be practiced in other aspects that depart from these specific details.

The accompanying drawings, where like reference numerals refer to identical or functionally similar elements throughout the separate views, together with the detailed description below, are incorporated in and form part of the specification, and serve to further illustrate aspects of concepts that include the claimed disclosure and explain various principles and advantages of those aspects.

The apparatuses and systems disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIG. 1 is a schematic diagram illustrating a system according to one or more embodiments of the present disclosure.

FIG. 2 is a schematic diagram illustrating a system according to one or more embodiments of the present disclosure.

FIG. 3 is a graph depicting an example of hydrate inhibitor requirements according to one or more embodiments of the present disclosure.

FIG. 4 is a flowchart of a method according to one or more embodiments of the present disclosure.

### DESCRIPTION

Numerous specific details are set forth to provide a thorough understanding of the overall structure, function, manufacture, and use of the aspects as described in the disclosure and illustrated in the accompanying drawings. Well-known operations, components, and elements have not been described in detail so as not to obscure the aspects described in the specification. The reader will understand that the aspects described and illustrated herein are non-limiting examples, and thus it can be appreciated that the specific structural and functional details disclosed herein may be representative and illustrative. Variations and changes thereto may be made without departing from the scope of the claims.

In the following description, it is to be understood that such terms as “forward,” “rearward,” “left,” “right,” “above,” “below,” “upward,” “downward,” and the like are words of convenience and are not to be construed as limiting terms.

Compressible fluids may be dispensed as pressurized streams in a gaseous or supercritical state. During a dispensing operation, a pressurized stream may be fed into a vessel until the contents thereof reach a sufficiently high density, which may depend on the intended use of the compressible fluid. For example, long-range compressed natural gas (CNG) trucking operations can require a fill fraction close to 100%, where the fill fraction is defined relative to the fluid's density at a reference pressure and temperature, such as, for example, 3,600 psig and 70° F.

Generally, contents of a fixed volume storage vessel may undergo increases in temperature during a continuous dispensing operation for compressible fluids due to the pressure-volume work done by the pressurized stream on the tank contents. Thus, a dispensing operation for compressible fluids may only achieve a desired fill fraction when a dispensing stream thereof is pressurized to higher-than-reference pressures. However, in practice, mere increases in dispensing pressures may not be sufficient to overcome these thermodynamic effects. For example, when dispensing CNG into a CNG tank, the temperature of the CNG tank may rise to a temperature greater than that of the CNG dispensing stream, such that a dispensing pressure for achieving a 100% fill would not be feasible due to process economics and process safety.

Conventional dispensing methods may rely on process chilling by means of auxiliary refrigeration to mitigate the issues specifically related to dispensing compressible fluids in a gaseous or supercritical state. However, the power required to operate such a process chiller for CNG dispensing operations may be significant and may not be available at a wellpad. Thus, operating a process chiller for a wellpad CNG dispensing operation may require importing electrical power, or a generation thereof via conversion of a portion of the produced natural gas, which may be undesirable in the context of operating a wellhead.

Various aspects of the present disclosure relate to strategic expansion of compressible fluids for dispensing operations. In particular, various systems and methods disclosed herein involve using an available pressure reduction of a first stream of a pressurized compressible fluid to reduce a temperature thereof, and subsequently transferring heat into the first stream from a second stream of compressible fluid to be dispensed in a gaseous or supercritical state. For example, a first stream of pressurized natural gas, which may be referred to as a slipstream, may undergo a significant reduction in temperature coinciding with an isenthalpic expansion thereof, and exchange heat thereafter with a second stream of natural gas, which may be referred to as a fill stream, to be dispensed further downstream.

As used herein, the term “isenthalpic” may refer to a thermodynamic process in which all of, or substantially most of, an enthalpy of a fluid flow is maintained, which may be accompanied by a significant decrease in temperature of the fluid flow. For example, isenthalpic expansions may include Joule-Thomson cooling, throttling processes, or other expansions where no shaft work is generated.

As used herein, the term “water-dry natural gas” may refer to a composition of a natural gas stream having a level of water appropriate for dispensing. For example, a stream of water-dry CNG may include a water content of 10 parts per million (ppm) or less based on the total mass flow of the stream.

As used herein, the term “compressed natural gas” and “CNG” may refer to natural gas dispensed by a CNG dispensing operation. Thus, references to the term CNG may not be inclusive of natural gas which has not already been conditioned for dispensing in a CNG dispensing operation, such as, for example, water-saturated natural gas or streams of water-dry natural gas which require further temperature and/or pressure conditioning prior to being dispensed into a storage vessel such as a CNG tank.

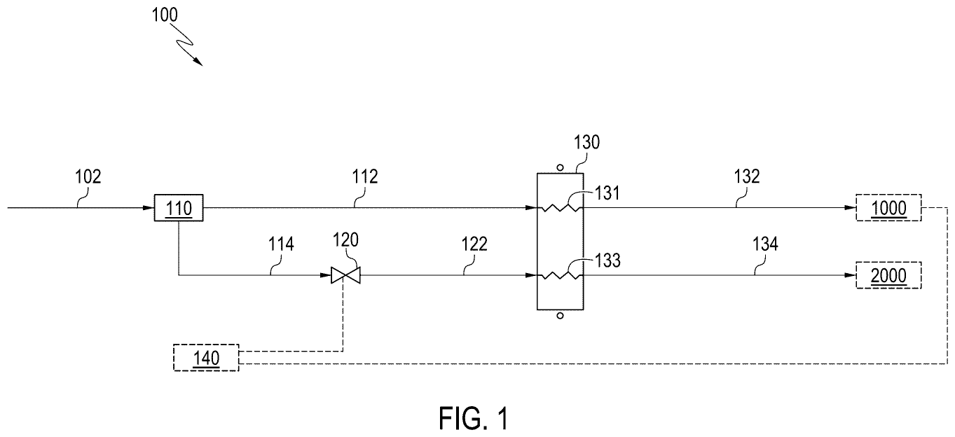

FIG. 1 is a schematic diagram of a system 100 for dispensing a compressible fluid according to one or more embodiments of the present disclosure. The system 100 may include a distributor 110, a flow regulator 120, and a heat exchanger 130. Each of the components of the system 100 may be connected to one or more other components by various lines. In the non-limiting example depicted in FIG. 1, the system 100 includes lines 102, 112, 114, 122, 132 and 134 for conveying compressible fluid, such as, for example, a stream comprising natural gas, into and away from various components in connection therewith. The system 100 may further include process instrumentation and/or sensors to indicate, or provide data associated with, temperatures and/or pressures along one or more of lines 102, 112, 114, 122, 132 and 134. As discussed herein, the system 100 may be used to process a stream of compressible fluid such that the compressible fluid may be dispensed onsite and/or discharged into downstream systems without importing external sources of energy. For example, compressible fluid in line 102 can comprise natural gas produced onsite at a wellpad, which may be water-dry natural gas from an onsite drier unit, and lines 132 and 134 may be in fluid communication with, respectively, an inlet junction of a CNG dispensing unit and a natural gas pipeline.

Compressible fluid in line 102 may be received by the flow distributor 110 and split thereby into outgoing streams conveyed via lines 112 and 114. Thus, the compositions of species flowing through lines 102, 112, and 114 may be similar or equivalent to one another. The distributor 110 may be configured to output streams at one or more flow ratios. For example, the distributor 110 may be a tee or a manifold to split flow of an inlet stream from line 102 into a plurality of flow paths in fluid communication with line 112 or line 114. Additionally, for the flow regulator 120 may be configured to control flow in line 114 and may include an actuator, such as a pneumatic, hydraulic, or electromechanical actuator. The flow regulator 120 may be in electronic communication with one or more flowmeters indicative of flowrates within lines 102, 112 and/or 114. The system 100 may include separate flowmeters incorporated along the flow paths of lines 102, 112 and/or 114. Thus, the flow regulator 120 may provide the ability to selectively control or regulate flow rates of lines 112 and 114 and/or a flow ratio therebetween.

The flow regulator 120 may receive a stream of compressible fluid via line 114 and discharge the stream via line 122. Compressible fluid flowing through flow regulator 120 may undergo an expansion from a first pressure to a second pressure lower than the first pressure. The flow regulator 120 may be configured based on properties of the compressible fluid and desired flow conditions thereof such that an expansion of the compressible fluid therein occurs with substantially no heat transfer with the surrounding environment. Thus, the flow regulator 120 may produce an outlet stream, such as compressible fluid in line 122, at a temperature significantly lower than the temperature of the compressible fluid of line 114. In various examples, the flow regulator 120 is configured to expand a flow of natural gas to produce an outlet stream having a temperature of −70° F. or greater, −60° F. or greater, −50° F. or greater, −40° F. or greater, −30° F. or greater, −20° F. or greater, or −10° F. or greater.

The flow regulator 120 may be a throttling device, such as a valve or an orifice, and may be configured to control an expansion of compressible fluid flowing therethrough based on an input to the flow regulator 120. For example, the flow regulator 120 can be an expansion valve having an adjustable control volume, which may be adjusted manually and/or based on one or more of an outlet temperature, an inlet temperature, an inlet pressure and an outlet pressure. In certain examples, the flow regulator 120 may be a thermal expansion valve including an actuator in thermal and/or fluid communication with another portion of the system 100, such that the actuator is directly responsive to fluctuations in downstream and/or upstream flows. Alternatively, the flow regulator 120 may be an electronic expansion valve including an actuator which may be controlled electronically.

The flow regulator 120 may rely on other non-isenthalpic mechanisms for expanding compressible fluid. For example, in another embodiment of the system 100, the flow regulator 120 may be a vortex tube which separates an inlet stream from line 114 into a first outlet stream, evacuated via line 122, and a second outlet stream higher in temperature than the first outlet stream evacuated via a separate line.

The heat exchanger 130 may include a first flow channel 131 for conveying fluid flow from line 112 to line 132 and a second flow channel 133 for conveying fluid flow from line 122 to line 134. The first flow channel 131 and the second flow channel 133 may be contained within a single unit, as depicted in FIG. 1, for example, to form a direct thermal interface such that heat may be exchanged between fluid flows of the first and second channels through a physical boundary defined by one or more of the first flow channel or the second flow channel. In other implementations, however, transfer of heat between respective fluid flows through the first flow channel and the second flow channel may be indirect. For example, a working fluid may be conveyed through a flow circuit as a heat transfer medium in contact with both the first flow channel at a first portion of the flow circuit and, at a second portion of the flow circuit, the second flow channel.

The heat exchanger 130 may be configured based on process conditions associated with downstream processes, which may include parameters such as, for example, flow rates, stream compositions, stream temperatures, and stream pressures. The heat exchanger 130 can be configured to cool an incoming stream of natural gas in line 112, which may be at a temperature in a range of about 80° F. to about 100° F. and at a pressure of about 4,000 psig. For example, the heat exchanger 130 may be configured to maintain a stream of natural gas, which may be water-dry, flowing in line 132 at a temperature appropriate for a downstream CNG dispensing operation, which may be in a range having a lower bound of −40° F., or −30° F., or −20° F., or −10° F., and an upper bound of 40° F., or 50° F., or 60° F. or 70° F. or 80° F. or 90° F. or 100° F. In various examples, the heat exchanger 130 is configured to maintain a stream of water-dry natural gas in line 132 at a temperature in a range of −10° F. to 90° F. Thus, the system 100 may selectively remove energy from streams of natural gas for a CNG fill trajectory via decompression of other preexisting streams of natural gas available onsite at a wellpad, thereby avoiding import of outside energy sources and mitigating issues associated with CNG filling operations related to filling efficiency.

Further to the above, the heat exchanger 130 may be configured to maintain the temperature at line 132 based on a minimum temperature difference, or design approach temperature, occurring within the heat exchanger 130 between streams flowing through the first flow channel 131 and second flow channel 133. For example, the heat exchanger 130 may have a design approach temperature of about 10° F., or about 15° F., or about 20° F., or about 30° F., based on streams of natural gas flowing through lines 131 and 132. In certain examples, the heat exchanger 130 is configured to have a design temperature approach of about 15° F.

Still referring to FIG. 1, compressible fluid in the first flow channel 131 may be discharged or transported to a dispensing unit 1000 via line 132. For example, the dispensing unit 1000 may be a CNG dispensing unit for filling a fixed volume CNG storage vessel, tank, and/or trailer. The dispensing unit 1000 may be configured to adjust a fill trajectory for continuously filling a CNG storage vessel. For example, the dispensing unit 1000 may be configured to selectively control, either by manual operation of the dispensing unit 1000 or by a control circuit thereof, a flow rate of natural gas therefrom into a storage tank based dispensing flow parameters and/or determined conditions within the storage tank.

Compressible fluid in the second flow channel 133 may be discharged therefrom via line 134. Since the cooling of the stream in line 112 is accomplished without chemically reacting the compressible fluid in line 122, such as by burning any natural gas therein, utilizing the system 100 can preserve a chemical utility of the compressible fluid which is not dispensed via line 132. In various embodiments, line 134 may be in fluid communication with a downstream process. For example, line 134 may be in fluid communication with a natural gas pipeline 2000.

The system may further include a control circuit 140, which may include at least one processor programmed to execute instructions stored on computer-readable media. The control circuit 140 may communicate with one or more of the flow regulator 120, the sensors or process instrumentation, other components such as valves of the system 100, and other control circuits described herein by any suitable wired or wireless communication protocols and interfaces such as 4-20 milliamp HART signal, Ethernet, fiber optics, coaxial, infrared, radio frequency (RF), a universal serial bus (USB), Wi-Fi®, cellular network, or the like. For example, the control circuit 140 may be in electrical communication with an actuator for a valve. The control circuit 140 may be in communication with a user interface to provide real-time feedback of one or more system 100 components to an operator. For example, the user interface may provide real-time feedback of the temperature and pressure of compressible fluid within line 132 and current flow ratio between flows of lines 112 and 114.

The control circuit 140 may be in direct and/or operative communication with components of the system 100. For example, the control circuit 140 may receive input signals via electronic communication with process instrumentation components of the system 100, such as one or more flow meters indicative of flow rates in lines 102, 112, and/or 114, and/or other sensors indicative of temperatures and/or pressures of the lines as discussed hereinabove. The control circuit 140 may also receive and generate electrical signals for communicating with an actuator associated with the flow regulator 120. Additionally, the control circuit 140 may include stored instructions to control flow rates via actuating various valves and flow regulators of the system 100 based on temperature and pressure data to achieve a setpoint. For example, the control circuit 140 may deliver a flow rate and temperature of compressible fluid in line 122, via adjusting actuators of flow regulator 120, based on desired a temperature and pressure setpoint for compressible fluid flowing in line 132.

Desired setpoints for operating the system 100 may be inputted via a user interface of the control circuit 140. Alternatively, or additionally, the control circuit 140 may interface with auxiliary systems to determine a setpoint and/or control signals associated therewith. For example, the control circuit 140 may be in communication with a control circuit of the dispensing unit 1000, such that a temperature, pressure, and/or flowrate setpoint for compressible fluid flowing in line 132 may be determined according to a particular fill trajectory and/or current status thereof in a storage vessel being fed by the dispensing unit 1000. Thus, the system 100 may interface with the dispensing unit 1000 to exchange data therebetween which may optimize aspects of a dispensing operation such as filling time, fill level and process safety.

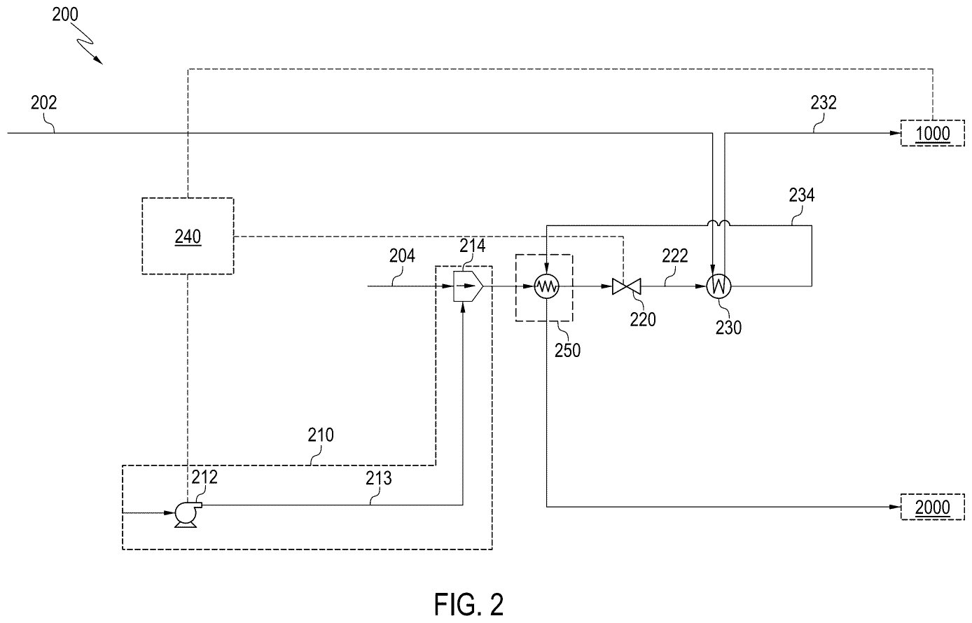

FIG. 2 is a schematic diagram of a system 200 according to one or more embodiments of the present disclosure. The system 200 may include a flow regulator 220, a primary heat exchanger 230 and control circuit 240. The system 200 may optionally include a modifier injection system 210 and/or a secondary heat exchanger assembly 250. Each of the components of the system 200 may be connected to one or more other components by various lines. In the non-limiting example depicted in FIG. 2, the system 200 includes lines 202, 204, 222, 232, and 234 for conveying various streams of compressible fluids, each of which may include flow meters, process instrumentation and/or sensors to indicate, or provide data associated with, flowrates, temperatures and/or pressures of fluid flow therein. In embodiments where the system 200 is configured for dispensing CNG, line 232 may feed a dispensing unit 1000 for CNG via a first flow junction and line 234 may be in fluid communication with a natural gas distribution pipeline 2000 via a second flow junction.

The flow regulator 220, primary heat exchanger 230, and control circuit 240 are similar in many respects to the flow regulator 120, heat exchanger 130, and control circuit 140 discussed above, which are not repeated herein at the same level of detail for the sake of brevity. Thus, the flow regulator 220 may be configured to lower a temperature of an incoming stream of compressible fluid in line 204 such that exchanging heat between compressible fluid in line 222 and compressible fluid in line 202 in heat exchanger 230 may sufficiently condition compressible fluid for dispensing from line 232. Additionally, the control circuit 240 may be configured to control various components of system 200 to achieve a setpoint appropriate for dispensing compressible fluid from line 232 according to a desired fill trajectory, which may be determined based on the control circuit 240 interfacing with dispensing unit 1000. Thus, the system 200 may efficiently dispense compressible fluid comprising CNG onsite at a wellpad without importing external sources of energy or conversion of chemical energy of the compressible fluid.

As discussed herein, the system 200 may accommodate variations in natural gas flow of lines 202 and 204 with respect to compositions thereof. For example, the system 200 may be configured to utilize water-saturated streams of natural gas in line 204. When subjected to low temperature and/or high-pressure conditions, the water content in a water-saturated natural gas stream may drive the formation of clathrate hydrates, which may be problematic with respect to maintaining predictable flow conditions, such as required in the context of maintaining reliable distribution pipelines. While water-saturated natural gas streams may not be problematic in line 204, the expansion thereof in flow regulator 220 may drive solids formation, which may be problematic with respect to an eventual discharge via line 234 into a natural gas distribution pipeline 2000. Additionally, the formation of solids may be problematic with respect to maintaining flow through passages in flow regulator 220 and/or heat exchanger 230, which may be tortuous and/or restricted. Clathrate hydrate formation may be inhibited by incorporating one or more hydrate inhibitors including thermodynamic hydrate inhibitors and/or low-dosage hydrate inhibitors. For example, adding a thermodynamic hydrate inhibitor such as methanol to a water-saturated natural gas stream may modify the phase behavior thereof such that clathrate hydrates are thermodynamically unfavorable at conditions associated with the system 200 and/or in a distribution pipeline. Examples of thermodynamic hydrate inhibitors may include simple alcohols such as methanol and ethanol, and glycols such as ethylene glycol, diethylene glycol and triethylene glycol. Examples of low-dosage hydrate inhibitors may include kinetic hydrate inhibitors, such as polymers or copolymers (e.g., polyvinylcaprolactam) or anti-agglomerants.

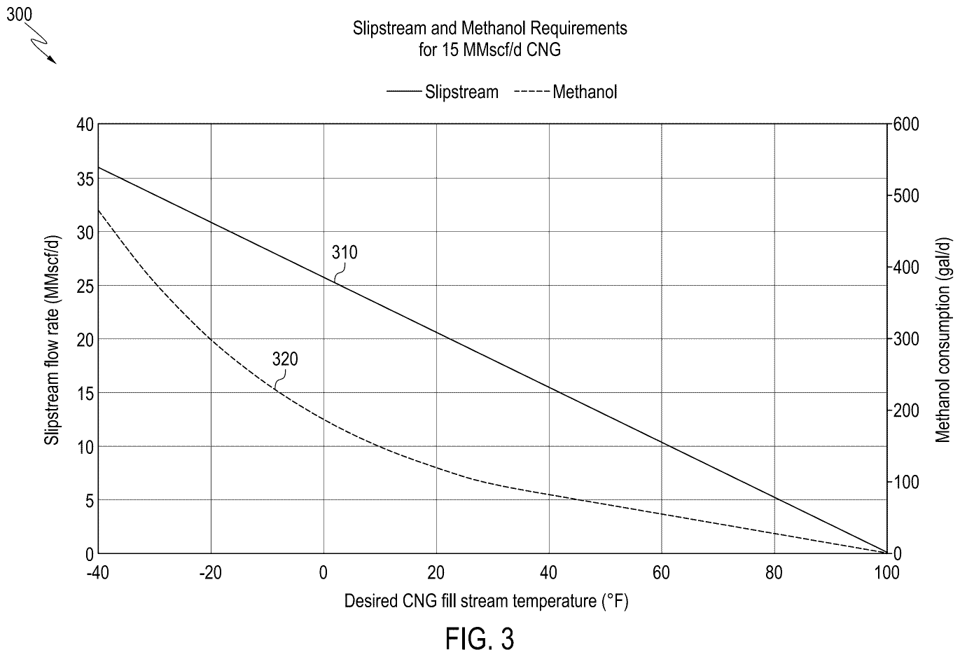

Now referring to FIGS. 2 and 3, the system 200 may include a modifier injector system 210 for injecting a hydrate inhibitor into a water-saturated natural gas stream to circumvent the issues related to the formation of clathrate hydrates as discussed hereinabove. The modifier injector system 210 may include a modifier pump 212 feeding an injector unit 214 via feed line 213. The injector unit 214 may be positioned inline with respect to line 204 upstream of flow regulator 220. The feed line 213 may additionally include a flow control device, such as a check valve, positioned prior to an injection point where hydrate inhibitor enters a primary flow channel of the injector unit 214 for the natural gas stream. The modifier injector system 210 may additionally include a flow meter in feed line 213. Additionally, the control circuit 240 may be in communication with the modifier pump 212 to inject an amount of modifier according to an injection schedule stored in memory of the control circuit 240. The injection schedule may be based on a flow rate of water-saturated natural gas in line 204 and a flow rate and temperature of water-dry CNG in line 232, and type of hydrate inhibitor. For example, FIG. 3 shows a graph 300 depicting an example of hydrate inhibitor requirements for modifying a natural gas slipstream when dispensing CNG with the system 200 in accordance with at least one non-limiting embodiment of the present disclosure. The graph 300 is provided with respect to a CNG dispensing rate of 15 million standard cubic feet per day (MMscf/d) and a methanol-based hydrate inhibitor. The flow rates of water-saturated natural gas 310 in MMscf/d and methanol consumption rate 320 in gallons per day (gal/d) required to suppress hydrate formation at points in the system 200 are provided with respect to desired CNG temperature to be dispensed. Thus, for a given CNG dispensing flowrate and hydrate inhibitor composition, the control circuit 240 may control modifier pump 212 to deliver a set flowrate in feed line 213 based on temperature in line 232 and flow rate in line 204. Incorporation of the modifier injector system 210 may reduce a drying bed capacity required for dispensing water-dry natural gas, thereby increasing available water-dry natural gas at a wellhead production site. Additionally, utilizing the modifier injector system 210 can allow the system 200 to utilize a variety of pressurized natural gas sources, which may include natural gas produced from a wellhead. Accordingly, dispensing CNG with a system 200 according to this configuration may further optimize onsite CNG dispensing operations.

Now referring back to FIG. 2, the system 200 may additionally include secondary heat exchanger assembly 250. The secondary heat exchanger assembly 250 may be positioned in the system 200 such that the natural gas stream originating from line 204 enters a first flow channel of the heat exchanger 250 and exits therefrom into the flow regulator 220. A second flow channel of the heat exchanger assembly 250 in thermal communication with the first flow channel thereof may receive line 234 from the outlet of primary heat exchanger 230 and convey flow therefrom downstream to a distribution pipeline 2000. The secondary heat exchanger assembly 250 may include multiple bypass valves for bypassing the first flow channel and/or the second flow channel.

Incorporating the secondary heat exchanger assembly 250 into the system 200 may accommodate variations in downstream CNG dispensing associated with traversing certain dispensing trajectories. For example, a desired CNG fill stream temperature associated with line 232, and thus, heat exchange therewith, may vary over the course of a CNG fill cycle by dispensing unit 1000. Accordingly, flow rate requirements through flow regulator 220 may vary over the course of a CNG fill cycle to accommodate the variations in heat exchange rates. The inventors of the present disclosure have determined that in situations wherein the desired temperature of CNG in line 232 is sufficiently low, employing the secondary heat exchanger assembly 250 may facilitate achieving such dispensing temperatures. For example, with respect to hydrate inhibitor modified slipstreams according to FIG. 3, CNG fill stream temperatures below about 28° F. may require the use of a secondary heat exchanger 250 in order for the slipstream 222 to achieve a sufficiently low temperature. The heat exchanger of the secondary heat exchanger assembly 250 may be bypassed in other situations where low temperatures are not required. In examples where the system 200 additionally includes modifier injector system 210, the secondary heat exchanger 250 may be positioned downstream thereof and upstream of flow regulator 220. The inventors of the present disclosure have determined that this positioning of the secondary heat exchanger may optimize the avoidance of clathrate hydrates.

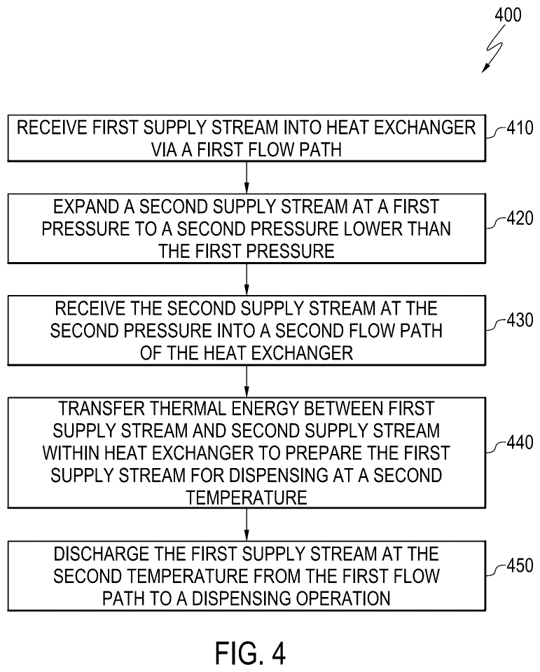

FIG. 4 is a flowchart of a method 400 for dispensing a compressible fluid according to one or more embodiments of the present disclosure. The method 400 comprises receiving 410 a first supply stream at a first temperature into a heat exchanger via a first flow path, expanding 420 a second supply stream at a first pressure to a second pressure that is lower than the first pressure, receiving 430 the second supply stream at the second pressure into a second flow path of the heat exchanger, transferring 440 heat between the first supply stream and the second supply stream within the heat exchanger to prepare the first supply stream for dispensing at a second temperature lower than the first temperature, and discharging 450 the first supply stream at the second temperature from the first flow path to a dispensing operation. The first supply stream comprises the compressible fluid to be dispensed by the dispensing operation following a temperature reduction thereof via the second supply stream. As such, in one or more embodiments, the first supply stream may be the fill stream, and the second supply stream may be the utility stream.

In various embodiments of the method 400, the compressible fluid may include CNG. In one or more embodiments, the first supply stream may be water-dry natural gas to be dispensed in a CNG fill operation for a fixed volume CNG tank. The CNG fill operation may include dispensing CNG according to a fill trajectory which varies the temperature of a fill stream. For example, the second temperature for discharging 450 the first supply stream may be in a range of −10° F. to 90° F., −10° F. to 80° F., −10° F. to 70° F., −10° F. to 60° F., −10° F. to 50° F. or −10° F. to 40° F. Discharging 450 CNG over a range of temperature based on fill percentage such that dispensing temperatures are reduced as fill percentages increase may facilitate continuous fill operations to a 100% fill, especially when starting from an empty state, which may be a nominally empty state. Additionally, utilizing lower dispensing stream temperatures may avoid requiring excessively high fill pressures for achieving a particular fill density. Thus, the method 400 may discharge 450 the first supply stream at sufficiently low temperatures such that dispensing pressures of 4,000 psig or less may be employed to achieve fill fractions at or near 100%. In one or more embodiments, the method 400 may include discharging 450 CNG continuously until reaching a predetermined fill state in a CNG tank, which may be at least 80%, 85%, 90%, 95%, 98%, or 99%, or about 100% based on at least one of a target density of the CNG or a reference pressure and temperature indicative thereof. In one or more embodiments, the target density corresponds to a pressure of at least 3,600 psig based on ambient temperature of about 70° F.

As used herein, the term “empty state” may refer to a fill state of a storage vessel which may not be completely free of gaseous contents therein (e.g., a vacuum state), but otherwise sufficiently depleted such that the vessel may require, or otherwise benefit from, being filled to satisfy a demand of a designated operation, such as, for example, a long-range CNG trucking operation. For example, a vessel scheduled for filling with CNG may be in a nominally empty state, the internal pressure of which may be as low as 200 psig.

Still referring to FIG. 4, the second supply stream may also comprise natural gas. In one or more embodiments, the method 400 further includes discharging the second supply stream from the heat exchanger into a natural gas pipeline. For example, the second supply stream discharged from heat exchanger may be natural gas at a temperature of at least −20° F. and a pressure at or above a distribution pipeline pressure. In various examples, a second supply stream of natural gas may be at a temperature suitable for discharge into a pipeline such as at a temperature of at least 40° F., at least 50° F., at least 60° F., at least 70° F., at least 80° F., at least 90° F., or at least 100° F.

In one or more embodiments of the method 400, the first supply stream and the second supply stream may originate from a common source, such as a stream of water-dry natural gas. Accordingly, the method 400 may additionally include portioning a pressurized stream of natural gas into a fill stream and a utility stream. However, in other embodiments, the first supply stream and the second supply stream may not originate from a common stream. For example, at least one of the first supply stream or the second supply stream may include natural gas produced from a wellhead, which may include various components such as water. Thus, in some embodiments, the method 400 may further include adding a hydrate inhibitor to natural gas to provide the second supply stream.

In one or more embodiments, the method 400 may further include transferring heat between an upstream portion of the second supply stream and a downstream portion of the second supply stream, the upstream portion comprising a portion of the second supply stream at the first pressure and upstream of the flow regulator, and the downstream portion comprising a portion of the second supply stream at the second pressure after transferring 440 heat with the first supply stream. Incorporating this secondary exchange of heat may facilitate reducing the temperature of the first supply stream to low temperatures, such as temperatures at or below 28° F. when the first supply stream is water-dry natural gas.

The foregoing detailed description has set forth various forms of the systems and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. None is admitted being prior art.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

What is claimed is:

1. A method for dispensing a compressible fluid, comprising:
receiving a first supply stream at a first temperature into a heat exchanger via a first flow path, the first supply stream comprising the compressible fluid;
expanding, via a flow regulator, a second supply stream at a first pressure to a second pressure that is lower than the first pressure, the second supply stream comprising the compressible fluid;
receiving the second supply stream at the second pressure into a second flow path of the heat exchanger;
transferring heat between the first supply stream and the second supply stream within the heat exchanger to prepare the first supply stream for dispensing at a second temperature lower than the first temperature; and
discharging the first supply stream at the second temperature from the first flow path to a dispensing operation.

2. The method of claim 1, wherein the compressible fluid comprises natural gas.

3. The method of claim 2, wherein the second temperature is in a range of −10° F. to 90° F.

4. The method of claim 2, wherein the first supply stream comprises water-dry natural gas.

5. The method of claim 1, wherein the dispensing operation comprises filling a tank via the first supply stream at the second temperature.

6. The method of claim 5, wherein the dispensing operation comprises filling the tank from a nominally empty state without interruption.

7. The method of claim 6, wherein the dispensing operation comprises continuously filling the tank until reaching a predetermined fill state based on at least one of:
a target density of the compressible fluid within the tank; or
a reference pressure and reference temperature indicative of the target density.

8. The method of claim 6, wherein the compressible fluid comprises natural gas and wherein a pressure of the first supply stream at the second temperature is no greater than 4,500 psig.

9. The method of claim 7, wherein the predetermined fill state is at least 80% of the target density.

10. The method of claim 2, wherein the second pressure is at or above a natural gas pipeline operating pressure.

11. The method of claim 10, further comprising discharging the second supply stream from the heat exchanger into a natural gas pipeline.

12. The method of claim 11, wherein transferring heat between the first supply stream and the second supply stream in the heat exchanger maintains the second supply stream being discharged at a temperature suitable for flowing into a natural gas pipeline.

13. The method of claim 1, comprising maintaining, via the flow regulator, the first supply stream being discharged at or below the second temperature.

14. The method of claim 1, comprising receiving at least one of the first supply stream or the second supply stream from a natural gas process stream produced onsite at a wellpad.

15. The method of claim 1, wherein the compressible fluid comprises natural gas, the second supply stream further comprising water and at least one hydrate inhibitor.

16. The method of claim 15, further comprising:
transferring heat between an upstream portion of the second supply stream and a downstream portion of the second supply stream, wherein the upstream portion comprises a portion of the second supply stream at the first pressure and upstream of the flow regulator, and wherein the downstream portion comprises a portion of the second supply stream at the second pressure after transferring heat with the first supply stream.

17. The method of claim 1, wherein the compressible fluid of the first supply stream within the heat exchanger is a supercritical fluid.

18. A method for filling a compressed natural gas (CNG) tank, comprising:
portioning a pressurized natural gas stream into a plurality of streams comprising a fill stream and a utility stream;
expanding, via a throttling device, a utility stream from a first pressure to a second pressure;
receiving the fill stream at a first temperature into a first flow channel of a heat exchanger;
receiving the utility stream at the second pressure into a second flow channel of the heat exchanger;
exchanging, via the heat exchanger, heat between the fill stream and the utility stream to reduce a temperature of the fill stream within the heat exchanger; and
continuously discharging the fill stream within the heat exchanger from the first flow channel into the CNG tank until reaching a fill state suitable for an extended use CNG operation.

19. The method of claim 18, wherein the pressurized natural gas stream is produced onsite from a wellhead.

20. A system for dispensing a first stream of pressurized natural gas onsite at a wellpad, comprising:
a flow regulator to expand a second stream of pressurized natural gas produced onsite at the wellpad into an expanded natural gas stream to reduce a temperature of the second stream based on the expansion;
a heat exchanger, comprising:
a first flow channel to accept the first stream of pressurized natural gas; and
a second flow channel to accept the expanded natural gas stream from the flow regulator, the second flow channel being in thermal communication with the first flow channel;
a first flow junction to convey the expanded natural gas stream from the second flow channel of the heat exchanger to a production pipeline system for downstream distribution of natural gas; and
a second flow junction to convey the first stream of pressurized natural gas from the heat exchanger into a wellpad compressed natural gas dispensing operation.
